(19) United States
(12) Patent Application Publication
(10) Pub. No.: US 2026/0146872 A1
(43) Pub. Date: May 28, 2026

(54) OPTICAL SENSING NETWORK

(71) Applicant: The University of Tulsa, Tulsa, OK (US)

(72) Inventors: Joshua Schultz, Tulsa, OK (US); John Garrett Williamson, Tulsa, OK (US)

(73) Assignee: The University of Tulsa, Tulsa, OK (US)

(21) Appl. No.: 19/400,309

(22) Filed: Nov. 25, 2025

Related U.S. Application Data
(60) Provisional application No. 63/725,129, filed on Nov. 26, 2024.

(51) Int. Cl. G01D 5/353

(52) U.S. Cl. CPC G01D 5/35345

(57) ABSTRACT

Methods and systems relating to deformable optical waveguides and forming them into an optical network. The optical network is formed from a plurality of optical waveguides that are bendable and stretchable using a plurality of I/O terminals. Each I/O terminal is switchable from an active light source, which provides light to the optical network, and an active light detector. The optical network may comprise two or more optical junctions. The optical junctions are formed from the optical waveguides, and the optical junctions split light pulses received into the optical junction to form multiple pathways between the I/O terminals. As light pulses pass through deformed segments of the optical network, the light experiences changes in amplitude and time-of-flight, which can be measured to determine the movement of an item monitored by the optical network.

### CROSS-REFERENCE TO RELATED APPLICATIONS

The present application claims the benefit of U.S. Provisional Patent Application Ser. No. 63/725,129, filed on Nov. 26, 2025, and entitled “OPTICAL SENSING NETWORK,” the disclosure of which is incorporated herein by reference in its entirety.

### STATEMENT REGARDING FEDERALLY SPONSORED RESEARCH OR DEVELOPMENT

This invention was made with government support under Contract/Grant No. 1935312 awarded by the National Science Foundation. The government has certain rights in the invention.

### FIELD

The present invention relates generally to force and strain sensors, and in particular to sensors for detecting deformations.

### BACKGROUND OF THE INVENTION

Stretchable sensors sensitive to deformation have numerous applications, including soft robotics applications, wearable technologies, motion capture for biomedical applications, and general shape reconstruction of high-deformation objects. For example, robotic arms, hands, or other tools made from soft, deformable materials make it difficult for the “brain” of a control system to know the location of its parts. Stretchable sensors can provide information on the pose of a soft body. Ideally, the elastic modulus and of the stretchable waveguide materials and the degree to which it could stretch would be close to that of a soft robot's or human skin. Therefore, stretchable waveguide sensors would provide conforming contact with the soft body being sensed at all times without changing the stiffness of the body, which is not achievable by rigid sensors.

Previous stretchable waveguide sensors have been found wanting in the ability to provide sufficient information on the magnitude and location of deformation. Further, such systems have been limited to providing information only in the exact location where that sensor is located and not to the broader area of the subject. That is, there must be many such individual sensors in order to provide deformation information over a substantial area.

For example, some prior art waveguides can only tell if the waveguide is deformed but cannot tell which type of deformation (pressure, bending, stretching, or twisting) is being applied. Furthermore, there is also no way to tell the location where the deformation occurs along the waveguide with previous designs. Distributed sensing using these waveguides requires many strategically placed sensors.

Other approaches in the prior art have been demonstrated to provide distributed sensing or location sensing, but have suffered from other downsides, such as (1) not being bendable and/or not being stretchable, so they cannot conform well to soft and stretchy bodies, (2) size and limited sensing area in the case of one waveguide that can detect the location and type of deformation applied along its length using light wavelength measurements, and therefore does not allow for compact and wireless sensing for small soft robot and wearable gadgets, and/or (3) being limited to the type of deformation detected, for example being sensitive only to pressure and not other types of deformations.

Based on the foregoing, there exists an unmet need for a sensor that addresses one or more of the aforementioned deficiencies and which can be integrated into a compact distributed sensor network capable of sensing a large area and locating deformations within that area.

### SUMMARY OF THE INVENTION

Generally, this disclosure relates to deformable optical waveguides suitable for use in forming an optical network, which is usable in monitoring deformations occurring in items, such as for soft robotics, biomedical applications, and general shape reconstruction of high-deformation objects. The deformable optical waveguides may have any or all of the following characteristics: compressible, bendable, and stretchable, as well as other modes of deformation.

For example, an optical network can be formed from a plurality of optical waveguides that are compressible, bendable, and stretchable using a plurality of I/O terminals. Each I/O terminal can be configured with internal light sources and light detectors such that each I/O may act as a source of pulsed light for the optical network or a light detector identifying light pulses passing through the optical network. Pulses of light provided by an I/O terminal pass through the waveguides of the optical network and are received at other I/O terminals operating as light detectors. A controller manages the operation of all I/O terminals, and the controller interprets the detection of light at I/O terminals acting as light detectors to determine regions of deformation within the optical network. Further, the controller provides the ability to switch each I/O terminal from a light pulse source to a light detector.

Further, the optical network typically will have three or more optical junctions. The optical junctions will generally have the same or similar mechanical properties as the optical waveguides. For example, the optical junctions can be formed from the optical waveguides and split light received into the optical junction to form multiple pathways between the I/O terminals, such that light entering the optical network from one of the I/O terminals will have multiple pathways to each of one or more of the other I/O terminals acting as light detectors.

In operation, the optical network is attached to an item to be monitored so that, as the item undergoes deformation, waveguides of the optical network are compressed, bent, and/or stretched, or otherwise deformed. Such deformation changes the amplitude and time-of-flight of light pulses traversing the optical network. From such changes, deformation for the segments and for the entire optical network can be measured using programming within the controller, and these changes reflect a deformation of the item that is being monitored.

Further details and aspects will become apparent by the disclosure hereunder.

### BRIEF DESCRIPTION OF THE DRAWINGS

The drawings included with this application illustrate certain aspects of the embodiments described herein. However, the drawings should not be viewed as exclusive embodiments. The subject matter disclosed herein is capable of considerable modifications, alterations, combinations, and equivalents in form and function, as will be evident to those skilled in the art with the benefit of this disclosure.

FIG. 1 is a schematic drawing depicting an optical waveguide.

FIGS. 2A, 2B, and 2C are schematic drawings illustrating how bending, compressing, and stretching affect amplitude and time-of-flight for light pulses passing through an optical waveguide in accordance with this disclosure.

FIG. 3 is a schematic drawing illustrating an optical junction containing four splitters with waveguides in accordance with this disclosure.

FIGS. 4A, 4B, and 5 are schematic drawings illustrating an optical network in accordance with this disclosure.

### DETAILED DESCRIPTION OF THE INVENTION

The present disclosure may be understood more readily by reference to the following description, including the figures. For simplicity and clarity of illustration, where appropriate, reference numerals may be repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may have been exaggerated to better illustrate details and features of the present disclosure.

Throughout this specification, when a concentration or amount or other parameter range is described as useful, or suitable, or the like, it is intended that any and every concentration or amount or other parameter within the range, including the endpoints, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the inventors appreciate and understand that any and all data points within the range are to be considered to have been specified, and that the inventors have possession of the entire range and all points within the range.

Broadly, this disclosure relates to deformable optical waveguides and methods and systems related thereto. The deformable optical waveguides may have any or all of the following deformation characteristics: compressible, bendable, and stretchable, as well as other deformation modes. The systems can be an optical network formed from the interconnection of the optical waveguides by splitting junctions (optical junctions). Such optical networks are usable in monitoring deformations occurring in items. For example, optical networks are useful for applications in soft robotics, biomedical applications, and applications involving general shape reconstruction of high-deformation objects. For example, in soft robotics, optical networks can measure deformation related to robotic hands, thus aiding in determining the position and location of the hands. For example, the optical network can be used in virtual reality applications, such as being used in association with a virtual reality glove or suit to aid in defining the position and location of the glove or suit, and hence reconstruct the motion of the wearer. The deformation information can be received by a controller, which can reconstruct the motion or positioning information. In some applications, the controller can use artificial intelligence or machine learning techniques to aid in the reconstruction of the motion or positioning information from the deformation information.

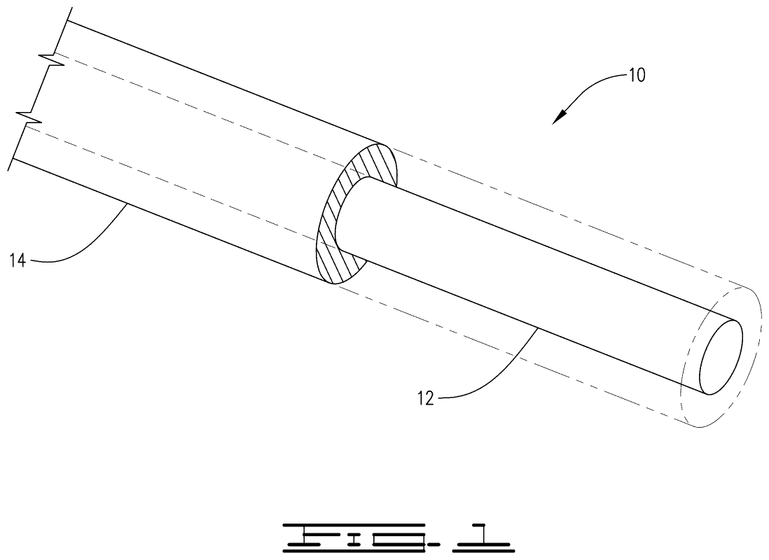

Turning now to FIG. 1, one suitable optical waveguide according to this disclosure will be described. FIG. 1 depicts optical waveguide 10 comprised of an optical core 12 and an optional optical cladding 14 (for reducing optical signal loss). As will be realized, the waveguide 10 has the appearance of a typical tubular-shaped optical cable, though the cross-section can be round, oval, square, etc. The core 12 and cladding 14 are each transparent; however, the cladding material has a lower refractive index than the core material. Thus, the optical waveguide 10 is capable of transmitting an optical signal comprising light waves. For example, core 12 and cladding 14 might transmit incident light of visible or infrared wavelengths. For example, the waveguide can transmit incident visible light having a wavelength of 400 to 750 nm. For example, the waveguide can transmit incident infrared light having a wavelength of greater than 750 nm, such as greater than 750 nm to 5000 nm, or 780 nm to 1000 nm.

The core 12 and cladding 14 are deformable so as to result in an optical waveguide that may have any one or all of the following characteristics: compressible, bendable, and stretchable, as well as other deformation modes. To this end, the core 12 and cladding 14 can comprise various elastomeric materials. Non-limiting examples of suitable elastomeric materials include various synthetic rubbers (e.g., silicone rubber, polyurethane, styrene-butadiene rubber, polybutadiene, neoprene, etc.), natural latex rubbers, biodegradable materials (e.g., polysebacic acid), or combinations thereof. While generally, the waveguide 10 will be comprised of a single core 12 encased by the cladding 14. It is within the scope of this disclosure for there to be multiple cores 12 covered by the cladding 14. In which case, each core 12 may comprise the same material(s) or different material(s) as long as the other parameters disclosed herein are met.

For example, the core 12 may consist of or comprise, for example, urethane. As used herein, “urethane” and “polyurethane” are interchangeable, with both equally referring to polyurethane. The optional cladding 14 may comprise, for example, silicone or air. Among its functions, cladding 14 protects the core-cladding interface from dust and oils that cause light to scatter out. As disclosed below, it is desirable for the core 12 and cladding 14 to have similar mechanical properties. Typically, core 12 and cladding 14 will have mechanical properties matching the object being monitored. To this end, additives, such as plasticizers, may be used. For example, the core 12 can be a polyurethane core (one such suitable polyurethane is Clear Flex™ 30 marketed by Smooth-On, Inc.) mixed with a plasticizer (such as So-Flex II™ marketed by Smooth-On, Inc.) so as to modify the mechanical properties of the core 12 to match a silicone cladding (such as Dragon Skin™ 10 or Dragon Skin™ 30 both marketed by Smooth-On, Inc.) with that cladding having also been matched to the object being sensed if the object being sensed is not itself the cladding.

Generally, soft silicone materials have refractive indices in the range of about 1.39-1.5, or 1.39-1.41, while soft urethanes are in the range of about 1.45-1.6, or 1.46-1.5. Thus, this pair provides for the cladding 14 to have a lower refractive index than the core 12. For some exemplary embodiments, the core 12 has a refractive index at least 0.05 greater than that of the cladding 14. For example, the core 12 may have a refractive index of 1.461, and the cladding 14 may have a refractive index of 1.41. As below, soft refers to having a Shore hardness from 00-30 to 60 A or some less included range.

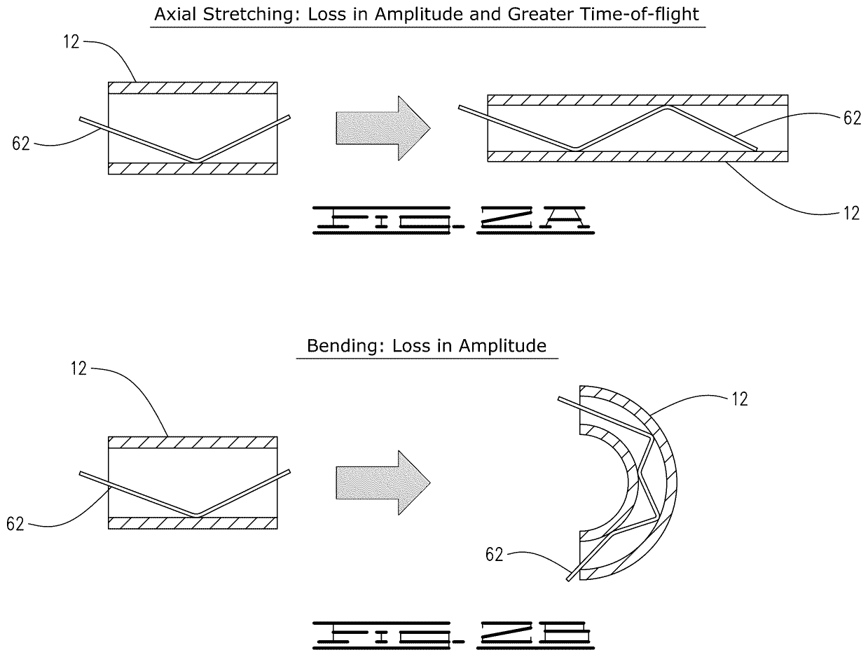

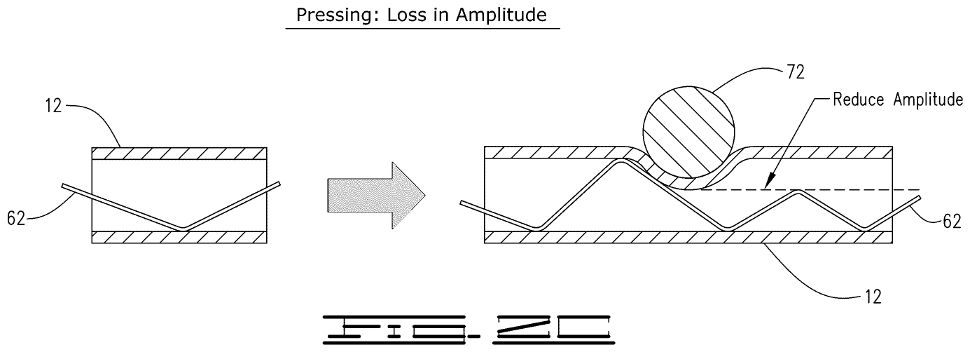

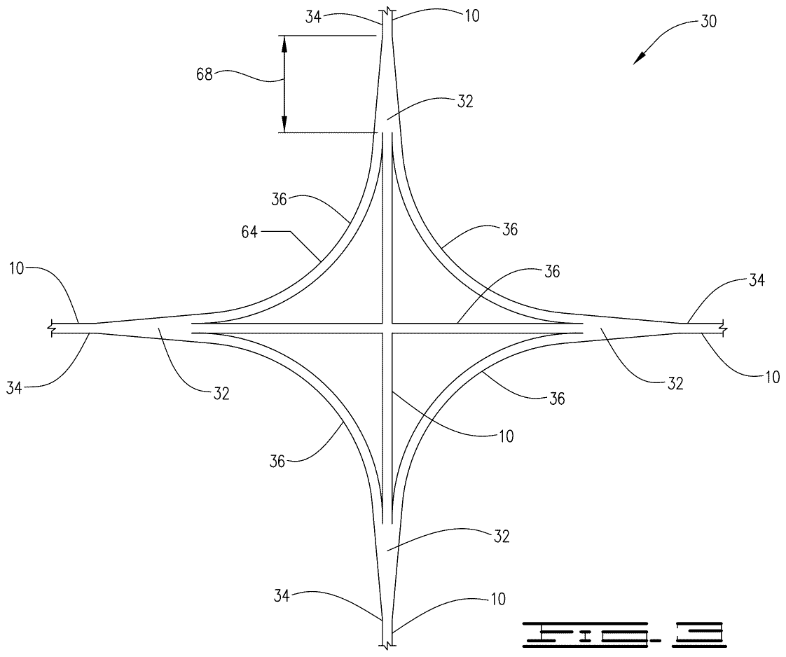

Optical waveguide 10 is made of (or made solely of) bendable and stretchable material. Optionally, optical waveguide 10 may be made of a compressible material such that the pathway of light transmission may be reduced locally at the point of depression. This makes the waveguide 10 (and the resulting optical network) adaptive and conformable to complex-shaped surfaces or objects that can deform. Stretchable optical waveguides are sensitive to deformations. The waveguide 10 output intensity decreases when the waveguide 10 is deformed in any possible way, such as pressed, bent, or stretched. For example, FIGS. 2A, 2B, and 2C illustrate how deformation, such as stretching (FIG. 2A), bending (FIG. 2B), and compressing by an object 72, such as a finger or other object (FIG. 2C), attenuates amplitude and alters time-of-flight for a pulse of light being transmitted through an optical waveguide 10 without blocking transmission of the light.

Typically, “bendable and stretchable” refers to the waveguide 10 (and its core 12 and cladding 14 components) being capable of >100% strain. That is, the strain from which the waveguide 10 may routinely recover may be, for example, more than 100%, more than 110%, more than 120%, more than 130%, more than 140%, more than 150%, more than 200%, more than 250%, or more than 300%. The allowable strain within which the optical waveguide 10 may still exhibit a fully elastic response may be as great as 300%, 400%, or 500%, for example. Exemplary materials for cores 12 and claddings 14 may be configured to withstand at least 400% elongation at break, e.g., 400% to 1000% elongation at break.

Additionally, the optical core 12 and optical cladding 14 can each have a Shore hardness such that they are “soft”; thus, the Shore hardness can be in a range from 00-30 to 60 A, or 00-40 to 50 A, or from 00-40 to 45 A, and optionally from 0A to 50 A, 00-40 to 35 A, or from 00-30 to 20, or from 00-30 to 10 A.

It has been discovered that it is advantageous to have the core 12 and cladding 14 have the same or similar mechanical properties as one another, and the object being sensed, if the object being sensed is not itself the cladding. A greater difference in mechanical properties between the core 12 and cladding 14 increases the likelihood of the core 12 and cladding 14 separating and not deforming together or not deforming with the object to which they are attached. With properly matched mechanical properties, the core 12 and cladding 14 are held together by their geometry and Van der Waals forces; thus, the optical waveguide 10 bends and stretches as a single unit, resulting in greater accuracy in detecting deformations when used in the optical networks 40 as described herein.

While not wishing to be bound by theory, it is currently believed that when matching mechanical properties, the most important thing to match is the rate-dependent stress-strain curves. In this respect, the 100% modulus is representative of matching those curves. 100% modulus, also known as “M 100”, is a measurement of the stress required to stretch a material to 100% strain at some rate. It is a common value used to compare viscoelastic materials.

By “same or similar” mechanical properties it is meant that the optical core 12 and optical cladding 14 each have a 100% modulus in a range from 25 kPa to 6 MPa such that both are close to the 100% modulus of the object being sensed if the object being sensed is not itself the cladding, though more typically the range is from 25 kPa to 600 kPa. Typically, the 100% modulus for the optical core 12 and optical cladding 14 will be at least 25 kPa, and optionally, at least 50 kPa, at least 75 kPa, at least 100 kPa, or at least 125 kPa. Typically, the 100% modulus will be no greater than 600 kPa, and optionally, no greater than 500 kPa, or no greater than 400 kPa. For example, the 100% modulus can be in the range of from 50 kPa to 500 kPa, or from 75 kPa to 400 kPa, or from 100 kPa to 400 kPa, or from 125 kPa to 400 kPa.

Typically, the 100% modulus of the optical cladding 14 will differ from the 100% modulus of the optical core 12 by no more than 50%, or no more than 40%, no more than 30%, or no more than 25%, or no more than 20%, or no more than 10%., or the 100% modulus of the optical cladding 14 will differ from the 100% modulus of the optical core 12 by no more than 100 kPa, or no more than 75 kPa, or no more than 50 kPa, or no more than 40 kPa.

In some embodiments, it may be desirable to coat the cladding of the waveguide with a jacket, which may or may not be transparent. Typically, if such a jacket is used, it will have the same or similar mechanical properties to the core 12, cladding 14, and sensed object.

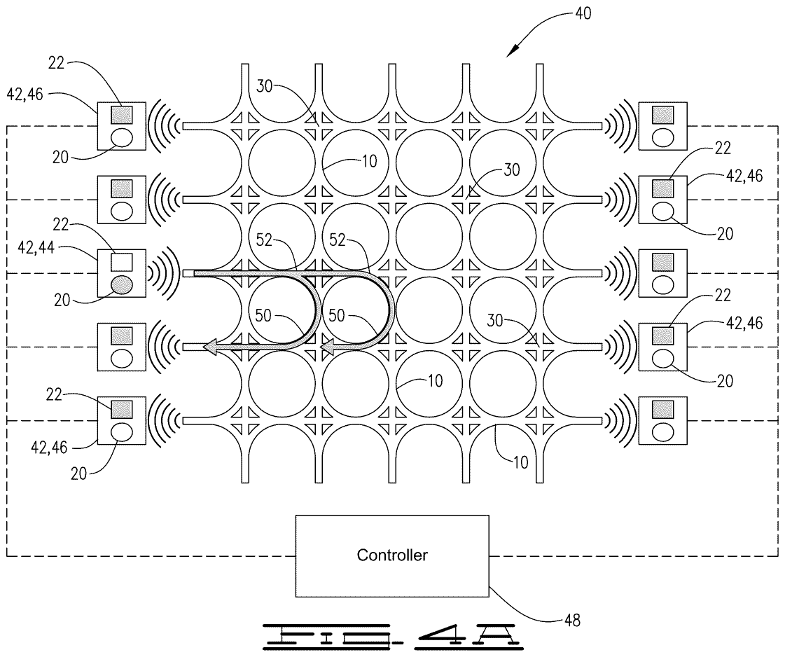

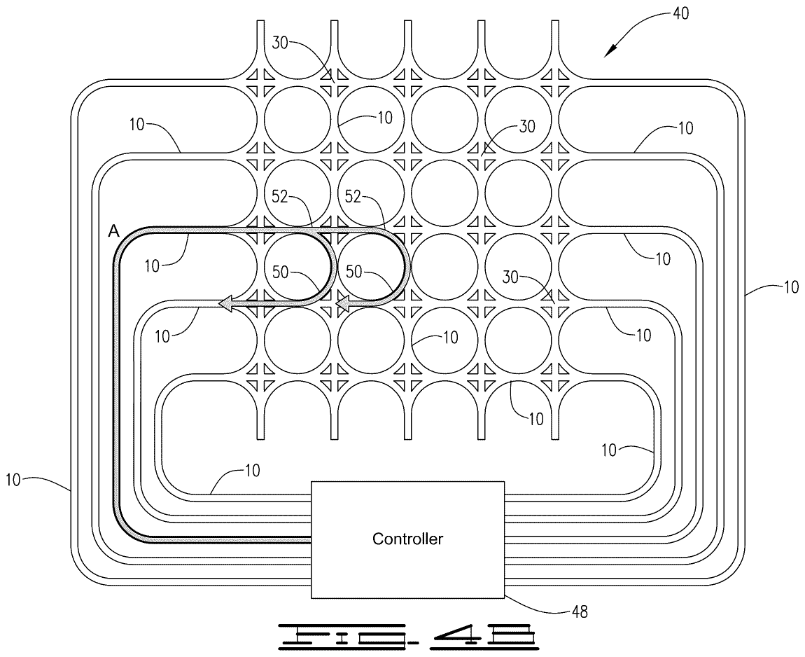

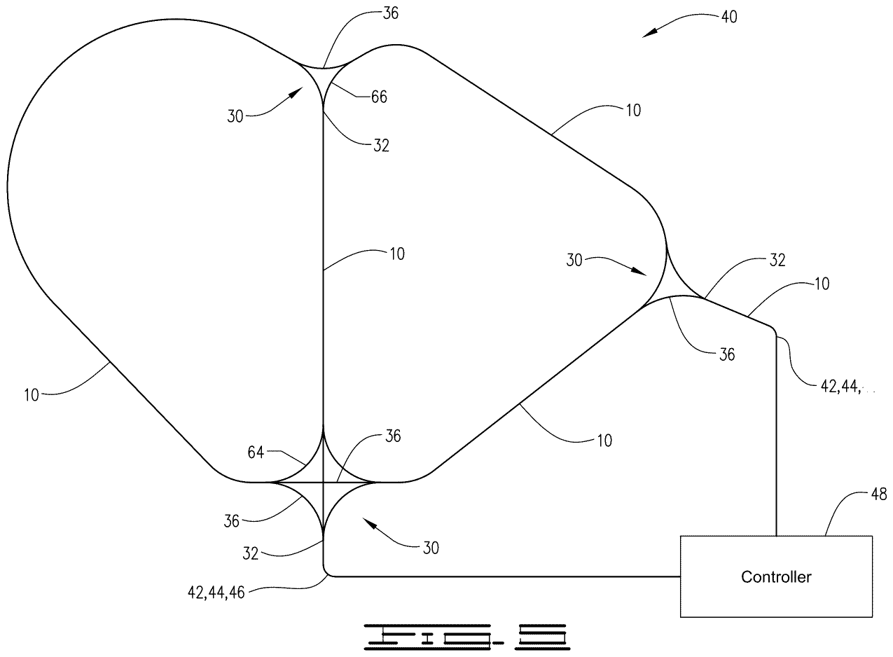

As shown in FIGS. 3 and 4A and 4B, optical network 40 includes a plurality of optical waveguides 10 interconnected by a plurality of optical junctions 30 and further includes a plurality of I/O terminals 42. I/O terminals 42 include internal light pulse sources 20 and light detectors 22. The depiction of I/O terminals 42 with internal light pulse sources 20, and light detectors is not to scale and does not necessarily represent the actual internal configuration of components. Each I/O terminal 42 is controlled by controller 48, which determines the operation of each I/O terminal 42. Thus, each I/O terminal 42 is switchable between operating as a light pulse source wherein pulsed light is produced by internal light sources 20 and operating as a light detector using light detectors 22. Thus, at least one I/O terminal 42 provides pulsed light to optical network 40. Typically, pulsed light enters at an optical junction 30.

Suitable light pulse sources 20 for use in I/O terminal 42 include, but are not limited to, lasers and other light emission devices capable of generating pulses of light in response to signals from controller 48. For example, one light source may be a broad-spectrum light source, such as white, a narrow band, or a single-wavelength source. The light source may be a visible-light source or an infrared-light source. In FIG. 4A, controller 48 has activated one light pulse source 20 in one I/O terminal 42 designated as 44. For the remainder of this disclosure, when I/O 42 has an activated light pulse source 20, that I/O terminal will be designated as I/O terminal 42, 44. As used herein, light pulse source 20 refers to a device capable of generating light in pulses, i.e. pulsed light, as directed by a communication from controller 48.

With further reference to FIGS. 4A and 4B, those I/O terminals 42 for which the light pulse source 20 is not active, the light detectors 22 will be active. These I/O terminals are designated as I/O terminals 42, 46. In general, only one I/O 42 will function as an active light pulse source. Therefore, most optical networks will have only one I/O terminal 42, 44 associated with any optical junction 30. More typically, only one I/O terminal 42, 44 will be associated with any optical network 40. The remaining I/O terminals 42 will function as light detectors 42, 46. In summary, I/O terminals 42, 44 provide pulsed light in response to signals from controller 48 into optical network 40, and I/O terminals 42, 46 detect light that has passed through optical network 40. Thus, I/O terminals 42 are switchable between light detecting and light transmitting operations.

Thus, in operation, controller 48 will signal light pulse source 20 to provide light pulses into optical network 40. As the light pulses pass through pathways 50 and pathway segments 52, deformation of those areas will attenuate the amplitude and/or alter the time of flight of the light pulses. Light pulses may exit optical network 40 at optical junctions 30 and enter I/O terminals 42, 46, where light detector 22 identifies the received light pulses. Light detector 22 is in communication with controller 48, which in turn compares the received light pulses to the generated light pulses to identify those portions of optical network 40 which were deformed.

As previously discussed, each I/O terminal 42 may be switched from an active light pulse source 20 to an active light detector 22. In the embodiment of FIG. 4A, I/O terminals 42 and their internal light pulse sources 20 and light sensors 22 are typically in electronic data communication with controller 48. However, as represented by FIG. 4B, I/O terminals 42, including their light pulse sensors 20 and detectors 22, may be located internally to controller 48, with each I/O terminal 42 connected to optical network 40 via waveguides 10 or other fiber optic waveguide.

FIG. 3 illustrates an optical junction 30, which is formed from optical waveguides 10 and optical splitters 32. The optical splitters 32 will generally have the same or similar mechanical properties as the optical waveguides 10; thus, optical splitters 32 are formed as per the optical waveguide 10 as described herein, though at least a portion of each optical splitter 32 can have a somewhat triangular shape. Accordingly, the optical splitters 32 and the optical junctions 30 are bendable and stretchable and optionally compressible or otherwise deformable. Optical junction 30 has a plurality of at least three access ends 34 where light can enter the optical junction 30 or leave the optical junction 30. As illustrated in FIG. 3, optical junction 30 has four access ends 34; however, as depicted in FIG. 5, the optical junction 30 can have three, four, and even more access ends 34. The configuration of optical junction 30, including the number of access ends 34, will be determined by the application or system being monitored by optical network 40.

In an optical junction 30 having four access ends 34, each access end is joined by an optical passage 36. As depicted in FIGS. 3 and 5, optical passages 36 defined by a centerline radius 64, with each radius of the optical junction 30 being substantially identical. The actual radius 64 will vary depending upon the application. FIG. 5 also depicts optical junction 30 having three access ends. In this optical junction, light passages 36 form radii 66. In general, radius 64 and radius 66 may have centerline radius ranging from about 15 mm and about 110 mm. More typically, radius 64 and radius 66 may range from about 15 mm to about 40 mm. Alternatively, each radius 64 may vary in order to permit splitting of light unevenly, such that each access end 34 receives a different light intensity. Depending on the application, optical splitters 32 will have a length 68, ranging from about 5 mm to about 20 mm. However, each of these ranges may vary with the application of optical network 40.

Each splitter 32 has associated access end 34 and forms at least two light-transmitting passages 36. Each light-transmitting passage 36 leads to another splitter 32. Note: light transmitting passages 36 are also optical waveguides 10. In this manner, a pulse of light entering a splitter 32 through an access end 34 is split and sent to each of the other splitters 32 via optical passages 36 forming the optical junction 30; however, light pulses entering a splitter 32 from a passage 36 are not split but are passed out of the access end 34 associated with that splitter 32. Thus, light pulses entering an access end 34 are split among, and exit from each of the other access ends 34. In this manner, light pulses generated by active light pulse source 20 of I/O 42 operating as a light pulse source point 44 are subsequently split among all available pathways and transmitted to I/O terminals 42 with active light detectors 22 designated as 46.

As illustrated in FIGS. 4 and 5, the optical junctions 30 can be connected together to form the optical network 40, where the multiple pathways 50 overlap and intersect at optical junctions 30 so as to form a plurality of pathway segments 52 and to form multiple pathways 50 between I/O terminals 42, as further discussed below.

A plurality of the access ends 34 of the optical junctions 30 are connected (either directly or through an optical waveguide 10) to I/O terminals 42 such that there are a plurality of I/O terminals 42 connected in a one-to-one relation with access ends 34 as illustrated in FIG. 4. In this manner, multiple pathways 50 between the I/O terminals 42 are formed such that light pulses emitted into the optical network 40 from one of the I/O terminals 42, 44 will have multiple pathways 50 to each of one or more of the other I/O terminals 42, 46.

For example, any I/O terminal 42 may have light pulse source 20 activated by controller 48. In the exemplary depiction of FIG. 4A, active light source 20 in I/O terminal 42, 44 is depicted as shaded, while inactive light pulse sources 20 in I/O terminals 42, 46 are unshaded. Likewise, in I/O terminals 42, 46, the active light detectors 22 are shaded, while in I/O terminal 42, 44, the inactive light detector 22 is unshaded.

Thus, as described above, controller 48 is operatively connected to the I/O terminals 42. Controller 48 can be one or more computing devices, such as a computer processor and associated software program. Thus, the controller 48 can be a hardware device and/or one or more software programs that manage or direct the flow of data, control the I/O terminals 42, and determine, compute, or compare the data to make determinations on deformations of the optical network 40 and/or an item to which it is attached. The controller 48 may include cards, microchips, or separate hardware devices for the control of the optical network 40 components. Thus, controller 48 manages the generation of light pulses entering optical network 40 and identifies changes in light pulses exiting optical network 40 at I/O terminals 42, 46. Controller 48 uses internal programming to calculate changes in pulsed light amplitude and or time-of-flight to determine the deformation of separate pathway segments 52 to determine the overall deformation of optical network 40, and in turn deformation of the component monitored by optical network 40.

The cooperation of I/O terminals 42, 46 with active light detectors 22 and controller 48 allows controller 48 to operate as a direct time-of-flight sensor. When pulsed light, having passed through the optical network 40 from an I/O terminal 42, 44 with an active light pulse source 20 encounters a pathway segment 52 which has been deformed, the pulsed light will experience a change in amplitude and/or calculated time-of-flight from I/O terminal 42, 44 to I/O terminal 42, 46 when compared to pulses of light passing through undeformed optical network 40. Controller 48 measures the delay (time) between when the light was emitted and when it is received at each I/O terminal 42, 46. Using the differences between original calculated time-of-flight and actual time-of-flight, controller 48 identifies those pathway segments which have been deformed. Thus, the delay can be based on the pathway the light takes through the network 40, and the delay for each of these pathways 50 can be affected by deformations of pathway segments 52. For example, stretching of a pathway segment 52 will increase the delay. Typically, multiple I/O terminals 42, 46 will have active light detectors 22, such that the time-of-flight data along different pathways 50 to different I/O terminals 42 can be detected.

Additionally, I/O terminals 42, 46 with active light detectors 22 may act as amplitude sensors by measuring the intensity of light pulses received as compared to the original intensity of light generated by light pulse source 20. That data is transmitted to controller 48, which in turn identifies those pathway segments 52 which have experienced a deformation. The intensity of light is directly proportional to the amplitude of the light wave. The light passes through the optical network 40 from an I/O terminal 42, 44 with active light pulse source 20 to I/O terminals 42, 46 with active light detectors. Thus, the active light detectors 22 provide controller 48 with the ability to determine the change in amplitude of the received light, and controller 48 can determine the pathway segment 52 which caused the change. Amplitude change can be based on deformation in the pathway 50 or pathway segment 52, the light takes through the network 40, such as bending or stretching, which will result in a loss of amplitude.

Additionally, I/O terminals 42 and controller 48 may be configured as additional sensors and different sensor types to obtain more information about the deformation of the optical network 40. For example, a configuration which uses either the time-of-flight sensor or amplitude sensor can be used separately in the optical network 40; however, use of both a time-of-flight sensor and an amplitude sensor at each I/O terminal 42 allows for more information on the deformation of the optical network 40. While described as separate sensors, it will be understood that the sensor can be a single sensor configuration that takes multiple types of readings. For example, controller 48 may be a VL53L8CH (marketed by STMicroelectronics), which is configured as a direct time-of-flight sensor that also takes amplitude data.

For example, by using both sensor configurations and switching the modes of the I/O terminals 42, light will take many different pathways 50 through the optical network 40 and be affected differently depending on the deformation of each pathway 50 or pathway segment 52. The controller can compare the data obtained from each of the I/O terminals 42. Also, the controller 48 can obtain the current data received from a specific I/O terminal 42 with the historic data of the I/O terminal 42, such as, but not limited to, when the optical network 40 had undergone no deformations.

As will be understood from this disclosure, light can take many pathways 50 in the disclosed optical network 40 to get from I/O terminal 42, 44 with active light pulse source 20 to I/O terminals 42, 46 with active light detectors 22. As an individual pathway segment 52 is deformed, the light pulses experience changes in amplitude, and the expected time-of-flight from I/O terminal 42, 44 to each I/O terminal 42, 46 also changes (and any pathways 50 incorporating that pathway segment 52 will experience a change). Because many pathways 50 overlap, the comparison of the different pathways 50 will give the deformation of each individual pathway segment 52 rather than just an overall pathway deformation.

Thus, where the multiple pathways 50 overlap and intersect at the optical junctions 30 so as to form a plurality of pathway segments 52 and to form multiple pathways 50 between an I/O terminal 42, 46 with active light detector 22 and I/O terminal 42, 44 with an active light pulse source 20, the controller 48 can be configured to determine changes in time-of-flight for individual pathways segments 52 such that deformation (stretching, bending, pinching, etc.) in the segments 52 can be determined. Additionally, the controller 48 can be configured to determine the deformation of each pathway 50 and of the entire optical network 40 based on the deformation in the segments 52.

In use, the optical network 40 can be attached to an item to be monitored for movement, positioning, or other motion detectable as a deformation. Accordingly, the optical network 40 has a primary benefit of conforming to an item to be monitored and paralleling movement or deformations that occur, which can be for the item as a whole or for a portion of the item. For example, if the item is a robotic hand, the deformation detected can be the bending of a single robotic finger and/or the bending of the entire hand.

Clearly, the data measured/obtained using the optical network 40 offers desirable information in applications such as, for example, real-time sensation in remote surgery, virtual reality (VR) glove, soft prosthetics and orthotics, and smart robotic hand and arms, and the like.

The following provides an exemplary use of the disclosed optical network 40. In this example, optical network 40 is used to monitor movement of a hand. Such monitoring may be done using a glove with an optical network 40 incorporated into the glove. In such an application, optical network 40 would ensure that pathways 50 and pathway segments 52 connecting junctions 30 lie over important sensing locations which will likely experience high deformation such as the knuckles which requiring bend sensing (corresponding to deformation depicted in FIG. 2B), fingertips requiring touch sensing corresponding to deformation depicted in (FIG. 2C), and the palm of the hand requiring both bend sensing (corresponding to deformation depicted in FIG. 2B) and stretch sensing (corresponding to deformation depicted in FIG. 2A). All access ends 34 would originate at the wrist and connect to an appropriate optical terminals 42 suitable for communicating with controller 48 to determine time of flight and amplitude changes. In addition, care should be taken to ensure the mechanical properties (such as shore hardness and 100% modulus) of the optical network 40 match the mechanical properties of the human hand as closely as possible.

In operation, a light pulse would be sent from an active light pulse source 20 associated with one of these I/O optical terminals 42. In FIG. 4, the I/O optical terminal 42 with an active light pulse source 20 is also designated 44. This light pulse would travel and split at junctions 30 into smaller light pulses as it went through the network. As each light pulse traveled through a deformed pathway segment 52, it would be affected by the deformation. As discussed above, a pathway segment 52 of the network that is stretched would delay the arrival time of light pulses traveling through it. When pathway segment 52 is bent or compressed, the impact on the light pulse will be a reduction in amplitude. Eventually, these light pulses would arrive at I/O optical terminals 42 with active light detectors 22, identified as I/O optical terminals 42, 46. The arrival time and amplitude of each light pulse (each representing a different path of travel through pathways 50 of optical network 40) can be compared to a known undeformed state to determine how much each pathway 50 has overall been deformed.

Knowing the layout of optical network 40 and the deformation of each pathway 50 allows the controller (48) to determine the overall deformation state of optical network 40. For instance, if two pathways 50 overlap as in FIG. 4A, but only one produces a different signal amplitude than the undeformed state, then it can be known that the deformation occurs in a pathway segment 52 where pathways 50 do not overlap. Changing which I/O optical terminals 42 have an active light pulse source 20 and which have active light detectors 22 will result in even more unique pathways 50 that can be compared by controller 48 to one another and to the known undeformed state. Controller 48 can use this information to determine each pathway segment 52 that has been deformed and, from that, determine how much each finger is bent, how hard a fingertip is pressing into an external surface, and how much the palm is bent and stretched. This gives an overall state of the hand's shape and contacts with the environment at any given time.

As will be realized in this disclosure, the presently-disclosed waveguide 10 and optical network 40 operates such that various deformations of the waveguide 10 cause distinctive light behavior, such as change in time-of-flight and change in amplitude, which can be analyzed along different pathways 50 and can be compared to complementary pathways 50 in the optical network 40 to measure and locate the deformations for individual pathway segments 52, the deformation of each pathway 50, and the deformation of the entire optical network 40. This can be accomplished without the use of dyes or color doping in the optical waveguides 10 or reflectors (such as mirrors and prisms but excluding the total internal reflection of the waveguide 10) in the optical junctions 30 or optical waveguides 10. In particular, the waveguide 10 may be used to differentiate pressing, stretching, and bending deformations, and/or to measure the location and magnitude of the deformation.

Embodiments of the waveguides 10 and optical network 40 of the present disclosure offer various capabilities, including, for example, detecting and differentiating local pressure, curvature, and/or elongation. The data measured/obtained using the sensors offers desirable information in applications such as, for example, real-time sensation in remote surgery, virtual reality (VR) glove, soft prosthetics and orthotics, and smart robotic hand and arms, and the like.

Examples of the above-described method and system can be further understood by the following numbered variations.

Variation 1: An optical network comprising:
a plurality of optical waveguides that are bendable and stretchable;
a plurality of I/O terminals, wherein each I/O terminal is configured to have an output mode in which light is emitted into an associated optical waveguide and an input mode in which light is received from the associated optical waveguide, and wherein the I/O terminal is switchable between the input mode and output mode; and three or more optical junctions, wherein said optical junctions are formed from at least a portion of the optical waveguides and split light received into the optical junction to form multiple pathways between the I/O terminals such that light emitted into the optical network from one of the I/O terminals will have multiple pathways to each of two or more of the other I/O terminals.

Variation 2: The optical network of variation 1, further comprising:
a controller; and
wherein each I/O terminal has one or more sensors, which are operably connected to or integrated into the I/O terminal and the controller, and wherein at least one of the sensors connect to each I/O terminal is a time-of-flight sensor and the controller is configured to receive time-of-flight data from the time-of-flight sensor and determine the amount of time light travels through at least one of the pathways. Alternatively, the controller acts as the direct time-of-flight sensor.

Variation 3: The optical network of variation 2, wherein the multiple pathways overlap and intersect at the optical junctions so as to form a plurality of pathway segments for each pathway and such that deformation in the segments based on the time-of-flight data can be determined.

Variation 4: The optical network of either variation 2 or variation 3, wherein the controller is configured to determine deformation in the segments based on time-of-flight data.

Variation 5: The optical network of variation 4, wherein the controller is configured to determine the deformation of the entire optical network based on the deformation in the segments.

Variation 6: The optical network of variation 1, further comprising:
a controller; and
wherein each I/O terminal has one or more sensors, which are operably connected to or integrated into the I/O terminal and the controller, and wherein at least one of the sensors connect to each I/O terminal is an amplitude sensor, and the controller is configured to receive amplitude data from the amplitude sensor.

Variation 7: The optical network of variation 2, wherein at least one of the sensors connect to or integrated into each I/O terminal, is an amplitude sensor, and the controller is configured to receive amplitude data from the amplitude sensor.

Variation 8: The optical network of variation 7, wherein the multiple pathways overlap and intersect at the optical junctions so as to form a plurality of pathway segments for each pathway, and such that deformation in the segments based on at least one of the time-of-flight data and amplitude data, and optionally on both time-of-flight data and amplitude data, can be determined.

Variation 9: The optical network of variation 8, wherein the controller is configured to determine deformation in the segments based on at least one of time-of-flight data and amplitude data, and optionally on both time-of-flight data and amplitude data.

Variation 10: The optical network of variation 9, wherein the controller is configured to determine the deformation of the entire optical network based on the deformation in the segments.

Variation 11: The optical network of any preceding variation, wherein the controller is configured to individually switch each of the I/O terminals between input mode and output mode by activating or deactivating the light sensors and light detectors.

Variation 12: The optical network of any preceding variation, wherein the optical junctions split light without the use of reflectors, and/or wherein there are three or more access ends, wherein light entering a first access end is split so as to exit from each of the other access ends.

Variation 13: The optical network of variation 12, wherein light entering one of the access ends other than the first access end exits the first access end and not one of the other access ends.

Variation 14: The optical network of any preceding variation, wherein each of the optical waveguides has an optical core and an optical cladding, wherein the optical core has a first index of refraction, and the optical cladding has a second index of refraction, and the first index of refraction is greater than the second index of refraction.

Variation 15: The optical network of variation 14, wherein the optical core and optical cladding each have a 100% modulus in a range from 25 kPa to 6 MPa such that both are close to the 100% modulus of the object being sensed if the object being sensed is not itself the cladding, though more typically the range is from 25 kPa to 600 kPa. Typically, the 100% modulus for the optical core 12 and optical cladding 14 will be at least 25 kPa, and optionally, at least 50 kPa, at least 75 kPa, at least 100 kPa, or at least 125 kPa. Typically, the 100% modulus will be no greater than 600 kPa, and optionally, no greater than 500 kPa, or no greater than 400 kPa. For example, the 100% modulus can be in the range of from 50 kPa to 500 kPa, or from 75 kPa to 400 kPa, or from 100 kPa to 400 kPa, or from 125 kPa to 400 kPa.

Variation 16: The optical network of variation 14, wherein the optical cladding has a 100% modulus which is the same or similar as the optical core, and optionally, the 100% modulus of the optical cladding will differ from the 100% modulus of the optical core by no more than 50%, or no more than 40%, or no more than 30%, or no more than 25%, or no more than 20%, or no more than 10%.

Variation 17: The optical network of variation 15 or variation 16, wherein the optical cladding has 100% modulus which is the same or similar as the optical core, and optionally, the 100% modulus of the optical cladding will differ from the 100% modulus of the optical core by no more than 100 kPa, or no more than 75 kPa, or no more than 50 kPa, or no more than 40 kPa.

Variation 18: The optical network of any of variations 14 to 17, wherein the optical core and optical cladding each have a Shore hardness in a range from 00-30 to 60 A, or 00-40 to 50A, or from 00-40 to 45 A, and optionally from 0A to 50 A, 00-40 to 35A, or from 00-30 to 20, or from 00-to 10 A.

Variation 19: A method comprising:
attaching an optical network to an item to be monitored, where the optical network comprises:
   a plurality of optical waveguides that are bendable and stretchable;
   a plurality of I/O terminals, wherein each I/O terminal is configured to have an output mode in which light is emitted into an associated optical waveguide and an input mode in which light is received from the associated optical waveguide, and wherein the I/O terminal is switchable between the input mode and output mode;
   three or more optical junctions, wherein said optical junctions are formed from at least a portion of the optical waveguides and split light received into the optical junction to form multiple pathways between the I/O terminals such that light emitted into the optical network from one of the I/O terminals will have multiple pathways to each of two or more of the other I/O terminals;
   a controller; and
   one or more sensors operably connected to the I/O terminal and the controller, and wherein at least one of the sensors connect to each I/O terminal is a time-of-flight sensor and the controller is configured to receive time-of-flight data from the time-of-flight sensor and determine the amount of time light travels through at least one of the pathways, and wherein the multiple pathways overlap and intersect at the optical junctions so as to form a plurality of pathway segments for each pathway and such that deformation in the segments based on the time-of-flight data can be determined; and
determining deformation in the segments based on time-of-flight data received by the controller.

Variation 20: The method of variation 19, further comprising determining the deformation of the entire optical network based on the deformation in the segments.

Variation 21: The method of either variation 19 or variation 20, wherein at least one of the sensors connect to each I/O terminal is an amplitude sensor, and the controller is configured to receive amplitude data from the amplitude sensor, and wherein the method further comprises determining deformation in the segments based on both time-of-flight data and amplitude data can be determined.

Variation 22. The method of any of variations 19, 20, or 21, further comprising individually switching each of the I/O terminals between input mode and output mode.

While the methods are described in terms of “comprising,” “containing,” or “including” various components or steps, the methods also can “consist essentially of” or “consist of” the various components and steps. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent(s) or other documents that may be incorporated herein by reference, the definitions that are consistent with this specification should be adopted.

Whenever a numerical range with a lower limit and an upper limit is disclosed, any number and any included range falling within the range are specifically disclosed. In particular, every range of values (of the form, “from a to b”, or “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Further, the terms “about”, “approximate”, and variations thereof are used to indicate that a value includes the inherent variations or error of the device, system, or method used to determine the value, or the variation that exists among the study subjects.

What is claimed is:

1. An optical network comprising:
a plurality of optical waveguides that are deformable without blocking transmission of light;
a plurality of I/O terminals, wherein each I/O terminal is configured to have an output mode in which light is emitted into an associated optical waveguide and an input mode in which light is received from the associated optical waveguide, and wherein the I/O terminal is switchable between the input mode and output mode; and
three or more optical junctions, wherein said optical junctions are formed from at least a portion of the optical waveguides and split light received into the optical junction to form multiple pathways between the I/O terminals such that light emitted into the optical network from one of the I/O terminals will have multiple pathways to each of two or more of the other I/O terminals.

2. The optical network of claim 1, further comprising:
a controller;
wherein each I/O terminal is in optical or electronic communication with the controller such that each I/O terminal provides data to the controller either as an optical transmission or an electronic transmission;
wherein the controller includes programming suitable for controlling each I/O terminal and activating a light source or a light detector associated with each I/O terminal; and,
wherein the controller further includes programming suitable for receiving and interpreting data received from each I/O terminal to determine at least one of a time-of-flight of a pulse of light sent into the optical network by the active light source and detected by the light sensors and a change in amplitude of the pulse of light sent into the optical network by the active light source and detected by the light sensors.

3. The optical network of claim 2, wherein the multiple pathways overlap and intersect at the optical junctions so as to form a plurality of pathway segments for each pathway and such that deformation in the segments based on the time-of-flight data can be determined.

4. The optical network of claim 3, wherein the controller is configured to determine deformation in the segments based on time-of-flight data.

5. The optical network of claim 4, wherein the controller is configured to determine the deformation of the entire optical network based on the deformation in the segments.

6. The optical network of claim 2, wherein at least one of the sensors connect to each I/O terminal is an amplitude sensor and the controller is configured to receive amplitude data from the amplitude sensor.

7. The optical network of claim 6, wherein the multiple pathways overlap and intersect at the optical junctions so as to form a plurality of pathway segments for each pathway and such that deformation in the segments based on at least one of the time-of-flight data and amplitude data can be determined.

8. The optical network of claim 7, wherein the controller is configured to determine deformation in the segments based on at least one of time-of-flight data and amplitude data.

9. The optical network of claim 8, wherein the controller is configured to determine the deformation of the entire optical network based on the deformation in the segments.

10. The optical network of claim 9, wherein the controller is configured to individually switch each of the I/O terminals between input mode and output mode.

11. The optical network of claim 10, wherein there are three or more access ends, wherein light entering a first access end is split so as to exit from each of the other access ends.

12. The optical network of claim 11, wherein each of the optical waveguides has an optical core and an optical cladding, wherein the optical core has a first index of refraction, and the optical cladding has a second index of refraction, and the first index of refraction is greater than the second index of refraction.

13. The optical network of claim 12, wherein the optical core and optical cladding each have a 100% modulus in a range from 25 kPa to 6 MPa.

14. The optical network of claim 13, wherein the 100% modulus of the optical cladding will differ from the 100% modulus of the optical core by no more than 50%.

15. A method comprising:
attaching an optical network to an item to be monitored, where in the optical network comprises:
a plurality of optical waveguides that are deformable without blocking transmission of light;
a plurality of I/O terminals, wherein each I/O terminal is configured to have an output mode in which light is emitted into an associated optical waveguide and an input mode in which light is received from the associated optical waveguide, and wherein the I/O terminal is switchable between the input mode and output mode;
three or more optical junctions, wherein said optical junctions are formed from at least a portion of the optical waveguides and split light received into the optical junction to form multiple pathways between the I/O terminals such that light emitted into the optical network from one of the I/O terminals will have multiple pathways to each of two or more of the other I/O terminals; a controller; and
one or more sensors operably connected to the I/O terminal and the controller, and wherein at least one of the sensors connect to each I/O terminal is a time-of-flight sensor and the controller is configured to receive time-of-flight data from the time-of-flight sensor and determine the amount of time light travels through at least one of the pathways, and wherein the multiple pathways overlap and intersect at the optical junctions so as to form a plurality of pathway segments for each pathway and such that deformation in the segments based on the time-of-flight data can be determined; and
determining deformation in the segments based on time-of-flight data received by the controller.

16. The method of claim 15, further comprising determining the deformation of the entire optical network based on the deformation in the segments.

17. The method of claim 16, wherein at least one of the sensors connect to each I/O terminal is an amplitude sensor and the controller is configured to receive amplitude data from the amplitude sensor, and wherein the method further comprises determining deformation in the segments based on both time-of-flight data and amplitude data can be determined.

18. The method of claim 17, further comprising determining the deformation of the entire optical network based on the deformation in the segments.

19. The method of claim 15, further comprising individually switching each of the I/O terminals between input mode and output mode.

20. An optical network comprising:
a plurality of deformable optical waveguides capable of transmitting light when deformed;
a plurality of I/O terminals, each I/O terminal having a light pulse source and a light detector;
at least two optical junctions, each optical junction configured to split light received into the optical junction and direct the light into multiple pathways, the multiple pathways connecting to at least one additional optical junction, wherein the optical junctions are also deformable;
a controller, the controller in data communication with each I/O terminal and the controller including programming such that the controller is configured to control each I/O terminal thereby directing the activation of the light pulse source or the activation of the light detector of each I/O terminal; and,
wherein the controller further includes programming for interpreting a transmission of a pulse of light from an active light pulse source to an active light detector.
